(19) United States
(12) Patent Application Publication
(10) Pub. No.: US 2010/0011974 A1
(43) Pub. Date: Jan. 21, 2010

(54) REFRESHMENT PREPARATION APPARATUS

(76) Inventor: David Onstott, Pasig City (PH)

Correspondence Address: BUTZEL LONG;IP DOCKETING DEPT, 350 SOUTH MAIN STREET, SUITE 300, ANN ARBOR, MI, 48104, US

(21) Appl. No.: 12/439,936

(22) PCT Filed: Sep. 4, 2007
(86) PCT No.: PCT/GB2007/003309

§ 371 Date: Sep. 16, 2009

(30) Foreign Application Priority Data
Sep. 5, 2006 (PH) I-2006-000424
Feb. 13, 2007 (GB) 0702718.8

(51) Int. Cl. A47J 43/00; B02C 23/00

(52) U.S. Cl. 99/538; 241/98

(57) ABSTRACT

A refreshment preparation apparatus (10) is described. The apparatus comprises a chilled pulveriser assembly for pulverising a frozen ingredient, a chilled storage assembly for storing the pulverised ingredient and dispensing apparatus (16) for dispensing the pulverished ingredient.

### FIELD OF THE INVENTION

The present invention relates to an improved refreshment preparation apparatus, particularly to an apparatus for preparing refreshments from frozen fruit.

### BACKGROUND OF THE INVENTION

Fruit is well known as a popular and healthy snack. A fruit based drink, when mixed with a chilled liquid to make, for example, a smoothie is an increasingly popular option for cooling down on a hot day.

Conventional refreshment makers such as juicers and smoothie machines, however, require the addition of ingredients such as cream, milk, ice or sparkling water. All of these ingredients are susceptible, particularly in hot countries to rapid deterioration.

Fruit based ice creams such as that described in Japanese Patent No JP 58036344 issued on 3 Mar. 1983 to Sakai Yoshihisa involves a typical refrigeration system, an ice cream cylinder mixer, a fruit juice tray connected to the ice cream cylinder mixer and a dispenser located outside the housing that dispenses the ice cream produced therein.

In this apparatus, a dairy liquid formula is loaded in a reservoir which is then transferred to the ice cream cylinder mixer. The ice cream cylinder mixer, which is provided with an agitator, slowly mixes the contents homogeneously until frozen transformed into a soft ice cream.

### SUMMARY OF THE INVENTION

According to a first aspect of the present invention there is provided a refreshment preparation apparatus comprising:
a chilled pulveriser assembly for pulverising a frozen ingredient;
a chilled storage assembly for storing the pulverised ingredient; and
dispensing apparatus for dispensing the pulverised ingredient.

Apparatus according to an embodiment of the present invention pulverises a frozen ingredient, such as a frozen apple or a frozen banana, to make a frozen fruit cream-like refreshment, the frozen fruit cream is then stored in the chilled storage assembly until it is desired to dispense the fruit cream through the dispensing apparatus. The refreshment has a soft, smooth texture, providing a particularly healthy and tasty refreshment manufactured purely from the frozen ingredient. As frozen ingredients are used, the ingredient is easily stored and preserved prior to use.

Preferably, the chilled pulveriser assembly comprises a pulveriser housing and a pulverising device.

Preferably, the pulverising device pulverises the frozen ingredient by a grinding or crushing action.

Alternatively, or additionally, the pulverising device pulverises the frozen ingredient by a squashing or squeezing action.

Alternatively, or additionally, the pulverising device pulverises the frozen ingredient by a shearing action.

Alternatively, or additionally, the pulverising device pulverises the frozen ingredient by a cutting action.

Preferably, interaction between the pulveriser housing and the pulverising device pulverises the frozen ingredient.

Preferably, the pulverising device is rotatable with respect to the pulveriser housing.

Preferably, the pulverising device is rotatable about a horizontal axis.

Preferably, the pulverising device is rotatably mounted to the pulveriser housing.

Alternatively, or additionally, the pulverising device is axially translatable with respect to the pulveriser housing.

Preferably, the pulverising device comprises at least one element.

Preferably, the pulverising device comprises a pair of elements.

Preferably, the at least one element is helical.

The at least one element may be a gear.

Preferably, the gear has a serrated edge.

Alternatively, the at least one element is a fluted cylinder.

Preferably, the fluted cylinder has a serrated edge.

Preferably, where there are two helical elements, the elements are at least partially intertwined. The frozen ingredient may be pulverised by being ground between the elements.

Alternatively, the frozen ingredient maybe pulverised by being ground between the at least one element and the pulveriser housing.

In one embodiment, where there are two elements, the elements may rotate in different directions.

The elements may define at least one serrated edge.

Alternatively, or additionally, the pulverising device comprises at least one ram.

In one embodiment, there may be two pulverising devices which travel in opposite directions.

Preferably, the pulveriser assembly comprises at least one frozen ingredient inlet and at least one pulverised ingredient outlet.

The at least one inlet and/or the at least one outlet may be chilled.

Preferably, the pulverising device is adapted to translate the frozen ingredient from the at least one frozen ingredient inlet to the at least one pulverised ingredient outlet.

Preferably, the pulverising device is adapted to transfer the pulverised ingredient to the/each pulverised ingredient outlet.

Preferably, the/each pulveriser assembly outlet is connected to a storage assembly inlet.

Preferably, the chilled storage assembly comprises a storage assembly housing and at least one storage assembly agitator. An agitator is provided to maintain the desired consistency of the frozen fruit cream.

Preferably, the/each agitator is rotatable with respect to the storage assembly housing.

Alternatively, or additionally, the/each agitator is axially translatable with respect to the storage assembly housing.

Preferably, the/each agitator is adapted to transfer the pulverised ingredient to the dispensing apparatus.

Preferably, the/each agitator is an Archimedes screw.

Where there are a plurality of agitators, the agitators may move in opposite directions to each other.

Preferably, the dispensing apparatus is a tap.

Preferably, the dispensing apparatus comprises a non-return valve.

Preferably, the pulveriser assembly is chilled by an evaporator coil.

Alternatively, the pulveriser assembly is chilled by a chilled jacket.

Preferably, the storage assembly is chilled by an evaporator coil.

Alternatively, the storage assembly is chilled by a chilled jacket.

Preferably, the refreshment preparation apparatus further comprises a refrigeration system.

Preferably, the refrigeration system is adapted to chill the pulveriser assembly and/or the storage assembly,

Preferably, the pulveriser assembly and/or the storage assembly are chilled to approximately 0° C.

Preferably, the refreshment preparation apparatus further comprises a frozen ingredient holding assembly. The ingredient holding assembly can be used to store the frozen ingredient prior to pulverising.

Preferably, the holding assembly is a hopper.

Preferably, the holding assembly comprises an agitator. An agitator is provided to prevent pieces of frozen ingredient sticking together.

Preferably, the agitator rotates around a vertical axis.

Preferably, a transfer device is provided to transfer, in use, the frozen ingredient to the pulveriser inlet.

Preferably, the device is a conical screw.

Preferably, the holding assembly is chilled. Ideally the holding assembly is chilled to approximately 0° C.

Preferably, the holding assembly comprises at least one holding assembly agitator.

Preferably, the at least one holding assembly agitator is adapted to agitate the frozen ingredient stored within the holding assembly. The agitator(s) prevent pieces of frozen ingredient sticking together or stocking to the sides of the holding assembly.

Preferably, the at least one holding assembly agitator is also adapted to feed the frozen ingredient into the chilled pulveriser assembly.

Preferably, the at least one holding assembly agitator comprises at least two cones.

Preferably, the at least two cones are cone gears.

Preferably, the frozen ingredient is frozen fruit.

Most preferably, the frozen ingredient is peeled frozen fruit.

According to a second aspect of the present invention there is provided a method of preparing a refreshment, the method comprising the steps of:
providing a frozen ingredient to a chilled pulveriser assembly;
pulverising the frozen ingredient; and
transferring the pulverised ingredient to a chilled storage assembly.

Preferably, the method further comprises the steps of:
transferring the pulverised ingredient from the chilled storage assembly to a dispensing apparatus; and
dispensing the pulverised ingredient.

It will be understood that preferred features of the first aspect may be applicable to the second aspect and are not repeated for brevity.

### BRIEF DESCRIPTION OF THE DRAWINGS

These and other aspects of the present invention will now be described by way of example only with reference to the accompanying drawings in which:

FIG. 1 is a perspective view of a refreshment preparation apparatus according to a first embodiment of the present invention;

FIG. 2 is a side view of the interior of the refreshment preparation apparatus of FIG. 1;

FIG. 3 is an exploded, partially cut-away side view of part of the interior of the refreshment preparation apparatus of FIG. 1; and

FIG. 4 is a partially cut away side view of part of a refreshment preparation apparatus according to a second embodiment of the present invention.

### DETAILED DESCRIPTION OF THE DRAWINGS

Referring to the drawings, a refreshment preparation apparatus, generally indicated by reference numeral 10, according to an embodiment of the present invention is shown. The refreshment preparation apparatus 10 comprises a chilled pulveriser assembly 12 for pulverising a frozen ingredient, a chilled storage assembly 14 for storing the pulverised ingredient and dispensing apparatus 16 for dispensing the pulverised ingredient.

The refreshment apparatus 10 also comprises a feed hopper 18, a chilled pulveriser assembly inlet 20, a chilled pulveriser assembly outlet 22, a motor 24 and a refrigeration system 26. The majority of the components of the refreshment preparation apparatus 10 are housed within a housing 28 which is moveable on four wheels 30.

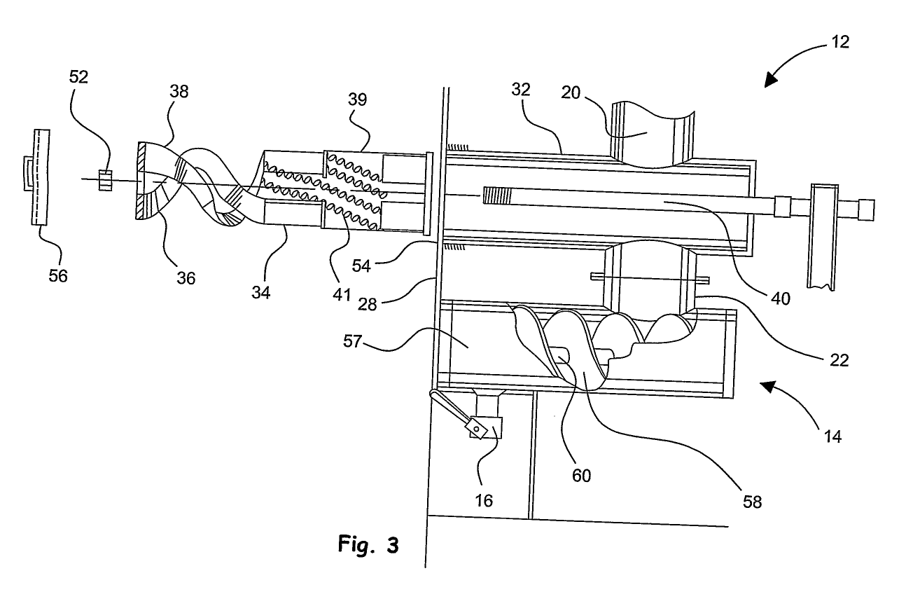

Referring to FIG. 3, it can be seen that the pulveriser assembly 12 comprises a pulveriser housing 32 and a pulverising device 34. The pulverising device 34 comprises a first helical blade 36, a second helical blade 38 and a grinding gear 39. The blades 36,38 are intertwined and are attached to the grinding gear 39. As can be seen from FIG. 3, the gear 39 defines a number of serrated edges 41.

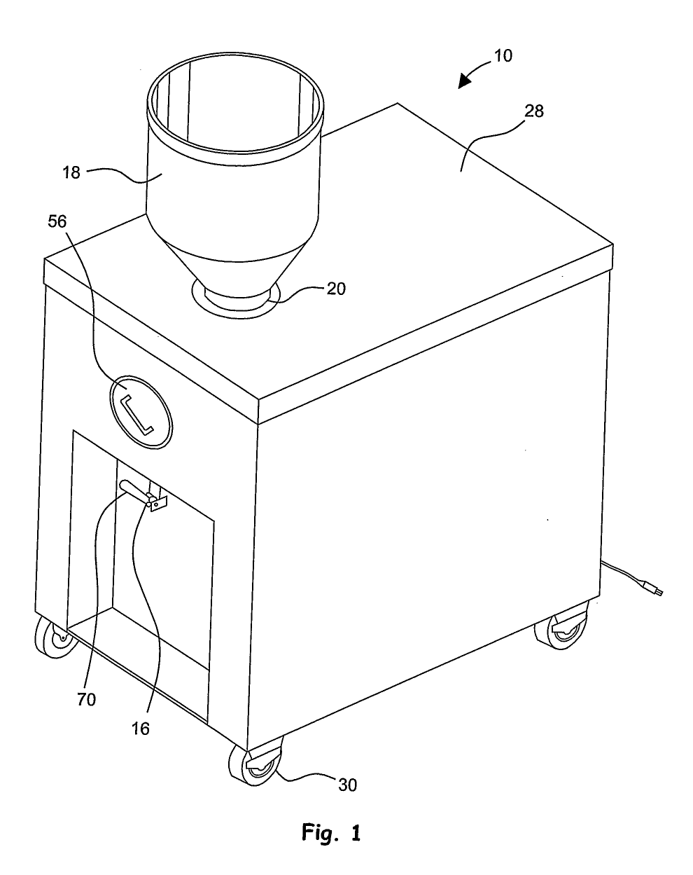

The blades 36,38 and the gear 39 are mounted to a pulveriser drive shaft 40 such that rotation of the shaft 40 rotates the blades 36,38 and the gear 39. The pulverising device 34 is releasably attached to the drive shaft 40 by means of a nut 52. This permits the pulverising device 34 to be removed from the pulveriser cylinder 32 for cleaning or sharpening, through an access hatch 54 in the front of the housing 28. In normal use the access hatch 54 is sealed by an access hatch cover 56. The access hatch cover 56 can be seen most clearly on FIG. 1.

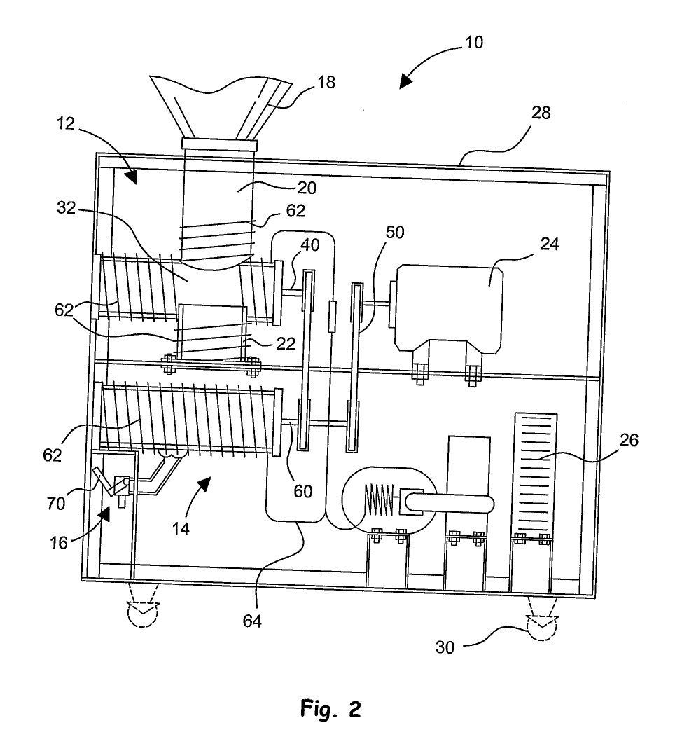

Referring to FIG. 2 the pulveriser drive shaft 40 is connected to the drive motor 24 by a system of belts and pulleys 50.

Referring back to FIG. 3, the storage assembly 16 comprises storage assembly housing 57 and an agitator 58 which is mounted to an agitator drive shaft 60. The agitator 58 is in the form of an Archimedes screw and is adapted to rotate and transfer the pulverised ingredient from the pulveriser assembly outlet 22 to the dispensing tap 16.

Referring to FIG. 2 the storage assembly drive shaft 60 is also connected to the drive motor 24 by means of the belt and pulley drive system 50.

As can be seen from FIG. 2, the pulveriser assembly inlet 20, the pulveriser assembly 12, the pulveriser assembly outlet 22 and the storage assembly 14 are all wrapped with evaporator coils 62. The evaporator coils 62 are attached to the refrigeration system 26 by means of a network of refrigerated pipes 64. The coils 62 maintain the temperature of these components 12,14,20,22 at approximately 0° C.

In use, one or more pieces of frozen fruit (not shown) of one or more differing types are introduced into the apparatus 10 through the hopper 18. The fruit feeds under gravity through the pulveriser assembly inlet 20 into the pulveriser assembly housing 32. The temperature of the frozen fruit is maintained around 0° C. by the refrigeration system 26 through the evaporator coil 62. Once in the pulveriser assembly housing 32, the fruit is pulverised into a fruit cream by rotation of the pulveriser blades 36,38 with respect to the pulveriser assembly housing 32.

Once pulverised, the frozen fruit passes through the pulveriser assembly outlet 22 into the storage assembly housing 57 where it is agitated by the agitator 58 to maintain the temperature and consistency of the pulverised fruit until it is dispensed through the dispensing tap 16 by actuation of a dispensing tap lever 70.

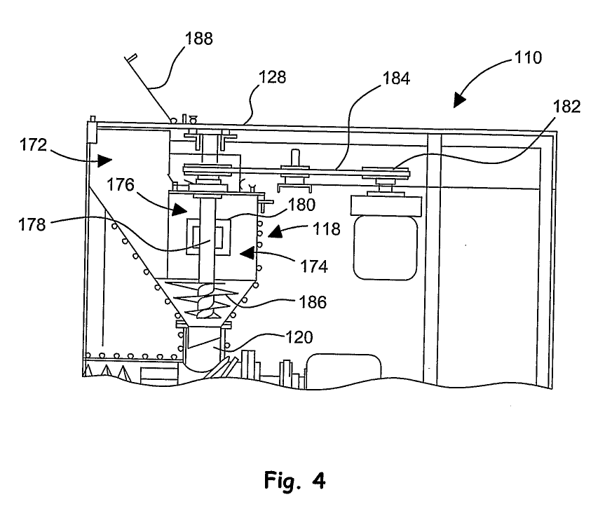

Referring now to FIG. 4, there is shown a partially cut away side view of part of a refreshment preparation apparatus 110 according to a second embodiment of the present invention. The apparatus 110 shown in FIG. 4 has a different arrangement of feed hopper 118 to the feed hopper 18 of FIGS. 1 to 3. The feed hopper 118 of the second embodiment is enclosed within apparatus housing 128 and comprises an access chute 172 leading to a chilled storage area 174. The access chute 172 is coverable by means of a hinged lid 188.

Within the storage area 174 there is a frozen ingredient agitator 176 comprising a rotatable shaft 178 and a pair of paddles 180. The agitator 176 prevents cubes or pieces of frozen ingredient sticking together. The shaft 178 is driven by a drive motor 182 via a drive belt 184. When the apparatus 110 is activated frozen ingredient is transferred from the chilled storage area 174 to the pulveriser assembly inlet 120 by a conical transfer screw 186.

Various modifications may be made to the above described embodiment without departing from the scope of the invention. For example, although the pulveriser assembly and the storage assembly are shown chilled by an evaporator coil, they could be chilled by circulation of fluid through a jacket surrounding these components. In a further alternative embodiment, the pulverising device could axially move with respect to the pulveriser assembly housing to squash the frozen fruit against the sides and ends of the pulveriser housing.

1. A refreshment preparation apparatus comprising:
a chilled pulveriser assembly for pulverising a frozen ingredient;
a chilled storage assembly for storing the pulverised ingredient; and
dispensing apparatus for dispensing the pulverised ingredient.

2. The refreshment preparation apparatus of claim 1, wherein the chilled pulveriser assembly comprises a pulveriser housing and a pulverising device.

3. The refreshment preparation apparatus of claim 2, wherein the pulverising device pulverises the frozen ingredient by at least one of a grinding, crushing, squashing, squeezing, shearing and cutting action.

4-65. (canceled)

66. The refreshment preparation apparatus of claim 2, wherein interaction between the pulveriser housing and the pulverising device pulverises the frozen ingredient.

67. The refreshment preparation apparatus of claim 2, wherein the pulverising device is axially translatable with respect to the pulveriser housing.

68. The refreshment preparation apparatus of claim 2, wherein the pulverising device comprises at least one element which comprises at least one of a gear and a fluted cylinder.

69. The refreshment preparation apparatus of claim 68, wherein the at least one element has a serrated edge.

70. The refreshment preparation apparatus of claim 68, wherein the at least one element is helical.

71. The refreshment preparation apparatus of claim 70, comprising two helical elements, wherein the elements are at least partially intertwined.

72. The refreshment preparation apparatus of claim 2, wherein the pulverising device comprises at least one ram.

73. The refreshment preparation apparatus of claim 1, wherein the pulveriser assembly comprises at least one frozen ingredient inlet and at least one pulverised ingredient outlet and wherein at least one of the frozen ingredient inlet and the pulverised ingredient outlet are chilled.

74. The refreshment preparation apparatus of claim 1, wherein the chilled storage assembly comprises a storage assembly housing and at least one storage assembly agitator.

75. The refreshment preparation apparatus of claim 74, wherein the agitator is adapted to transfer the pulverised ingredient to the dispensing apparatus.

76. The refreshment preparation apparatus of claim 74, wherein the agitator is an Archimedes screw.

77. The refreshment preparation apparatus of claim 73, wherein a transfer device is provided to transfer, in use, the frozen ingredient to the pulveriser inlet, and wherein the transfer device is a conical screw.

78. The refreshment preparation apparatus of claim 1, including a chilled holding assembly.

79. The refreshment preparation apparatus of claim 78, wherein the holding assembly comprises at least one holding assembly agitator.

80. The refreshment preparation apparatus of claim 79, wherein the at least one holding assembly agitator is adapted to feed the frozen ingredient into the chilled pulveriser assembly.

81. The refreshment preparation apparatus of claim 79, wherein the at least one holding assembly agitator comprises at least two cones.

82. The refreshment preparation apparatus of claim 81, wherein the at least two cones are cone gears.
